(19) United States
(12) Patent Application Publication
(10) Pub. No.: US 2007/0031642 A1
(43) Pub. Date: Feb. 8, 2007

(54) Adhesive tape for a flexible display device and method of manufacturing a flexible display device using the same

(75) Inventors: Woo-Jae Lee, Yongin-si (KR); Hyung-II Jeon, Incheon-si (KR); Jong-Hyun Seo, Incheon-si (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/499,986

(22) Filed: Aug. 4, 2006

(30) Foreign Application Priority Data
Aug. 5, 2005 (KR) 10-2005-0071745

(51) Int. Cl. B32B 3/00

(52) U.S. Cl. 428/172; 428/354

(57) ABSTRACT

An adhesive tape for a flexible display device and a method of manufacturing a flexible display device using the same are provided. The adhesion tape for a flexible display device includes a supporting film; a first adhesive layer formed on a first surface of the supporting film and having an uneven surface; and a second adhesive layer formed on a second surface of the supporting film. Accordingly, separation between the supporter and the flexible substrate may be prevented during the manufacturing process, even if the adhesive layers do not have strong adhesive ingredients. Therefore, the production yield of a flexible display device may be improved and the manufacturing process simplified.

### CROSS-REFERENCE TO RELATED APPLICATION

This Application claims priority from Korean patent application number 10-2005-0071745 filed on Aug. 5, 2005, and all the benefits accruing therefrom under 35 U.S.C. §119, the contents of which are incorporated by reference herein in its entirety.

### BACKGROUND OF THE INVENTION

(a) Field of the Invention

The present invention relates to an adhesive tape for a flexible display device and a method of manufacturing a flexible display device using the same.

(b) Description of the Related Art

A liquid crystal display (LCD) and an organic light emitting display (OLED) are the most widely used flat panel displays.

A typical LCD includes two panels provided with field-generating electrodes, such as pixel electrodes and a common electrode, polarizers, and a liquid crystal (LC) layer interposed between the two panels. The LCD displays images by applying voltages to the field-generating electrodes to generate an electric field in the LC layer, which determines orientations of LC molecules in the LC layer to adjust the polarization of incident light.

A typical organic light emitting diode display (OLED) is a self emissive display device, which displays images by exciting an emissive organic material to emit light. The OLED includes an anode (hole injection electrode), a cathode (electron injection electrode), and an organic light emission layer interposed therebetween. When the holes and the electrons are injected into the light emission layer, they are recombined and the pair is annihilated while emitting light.

Disadvantageously, the liquid crystal display and the organic light emitting display include a fragile and heavy glass substrate, which make the displays unsuitable for portable use or for the manufacture of a large scale display.

Accordingly, a display device using a flexible substrate made of a material such as plastic that is light and strong has recently been developed. However, because a plastic substrate easily bends and expands when heated, thin film patterns such as electrodes and signal lines are difficult to form thereon.

### SUMMARY

The present invention provides a more suitable manufacturing process in a manufacturing method of a flexible display device without a bend phenomenon. An adhesive tape for a flexible display device and a method of manufacturing a flexible display device using the same are provided.

In accordance with an embodiment of the present invention, an adhesion tape for a flexible display device is provided, which includes a supporting film, a first adhesive layer formed in one surface of the supporting film and having one uneven surface, and a second adhesive layer formed in the other surface.

In accordance with another embodiment of the present invention, a method of manufacturing a flexible display device is provided, which includes adhering one uneven surface of an adhesion tape to one surface of a flexible substrate, adhering a supporter to the other surface of the adhesion tape, forming a thin film pattern on the other surface of the flexible substrate; and separating the flexible substrate from the supporter.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

The above and other advantages of the present invention will become more apparent by describing embodiments thereof in detail with reference to the accompanying drawings, in which:

FIG. 1 is a sectional view illustrating an adhesive tape for a flexible display device according to an embodiment of the present invention;

FIG. 2 is a sectional view illustrating an adhesive tape for a flexible display device according to another embodiment of the present invention;

FIGS. 3 to 6 are sectional views illustrating a manufacturing method of a flexible display device according to an embodiment of the present invention;

FIG. 7 is a layout view of a thin film transistor array panel for an LCD according to an embodiment of the present invention;

FIGS. 8A and 8B are sectional views of the LCD shown in FIG. 7 taken along the lines VIIIA-VIIIA and VIIIB-VIIIB, respectively;

FIGS. 9, 11, 13, and 15 are layout views of a TFT array panel shown in FIGS. 7, 8A, and 8B in intermediate steps of a manufacturing method thereof according to an embodiment of the present invention;

FIGS. 10A and 10B are sectional views of the TFT array panel shown in FIG. 9 taken along the lines XA-XA and XB-XB, respectively;

FIGS. 12A and 12B are sectional views of the TFT array panel shown in FIG. 11 taken along the lines XIIA-XIIA and XIIB-XIIB, respectively;

FIGS. 14A and 14B are sectional views of the TFT array panel shown in FIG. 13 taken along the lines XIVA-XIVA and XIVB-XIVB, respectively;

FIGS. 16A and 16B are sectional views of the TFT array panel shown in FIG. 15 taken along the lines XVIA-XVIA and XVIB-XVIB, respectively; and

FIGS. 17A to 17D are sectional views of a common electrode panel in intermediate steps of a manufacturing method thereof according to an embodiment of the present invention.

Embodiments of the present invention and their advantages are best understood by referring to the detailed description that follows. It should be appreciated that like reference numerals are used to identify like elements illustrated in one or more of the figures. It should also be appreciated that the figures may not be necessarily drawn to scale.

### DETAILED DESCRIPTION

The present invention will now be described more fully hereinafter with reference to the accompanying drawings, in which embodiments of the invention are shown. The present invention may, however, be embodied in many different forms and should not be construed as limited to the embodiments set forth herein.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present. In contrast, when an element is referred to as being “directly on” another element, there are no intervening elements present.

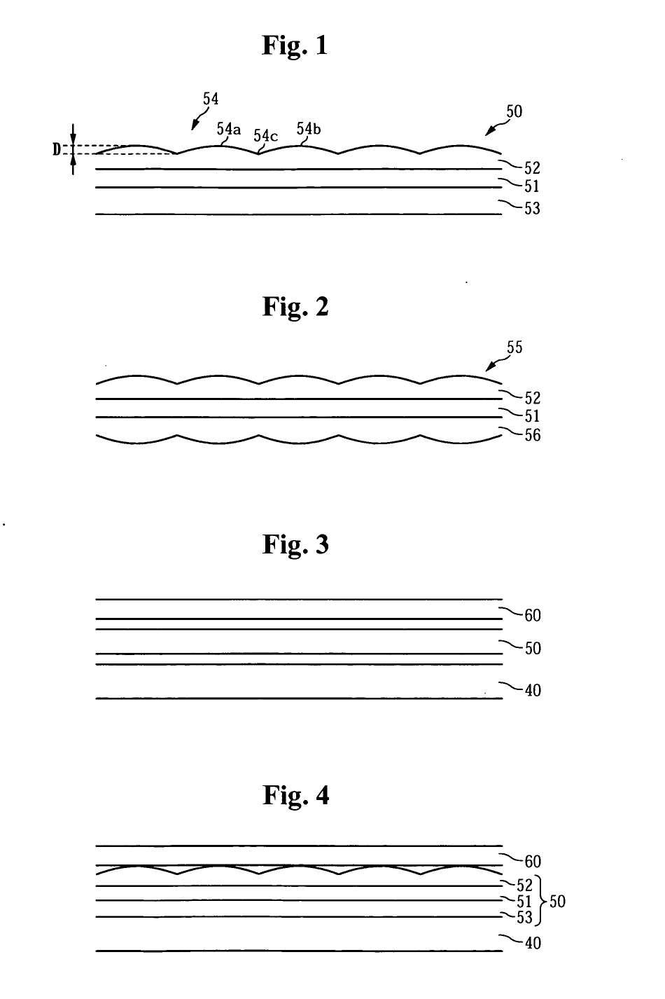

Firstly, an adhesive tape for a flexible display device according to an embodiment of the present invention will be described in detail with reference to FIGS. 1 and 2.

FIG. 1 is a sectional view illustrating an adhesive tape for a flexible display device according to an embodiment of the present invention. An adhesion tape 50 according to an embodiment of the present invention includes a supporting film 51 and first and second adhesive layers 52 and 53 coated on both adhesive surfaces of the supporting film 51.

The supporting film 51 is a base portion to maintain the form of the adhesion tape 50, and may be made of polyimide or polyethylene terephthalate (PET) in one example. However, the supporting film 51 is not restricted to these materials and various materials may be used.

The first adhesive layer 52 coated on one surface of the supporting film 51 is directly contacted to a flexible substrate (not shown), and the one surface 54 of the first adhesive layer 52 is uneven.

The uneven surface 54 of the first adhesive layer 52 is used as a passageway to exhaust bubbles that are generated and formed between the first adhesive layer 52 and the flexible substrate.

The uneven surface 54 includes a plurality of protrusion portions 54a and 54b and a plurality of depression portions 54c therebetween. It is preferable that an interval between the heights of the protrusion portions 54a and 54b is in the range of 5-500 microns. If the interval is less than 5 microns, the uneven surface 54 may not be able to function as the passageway to exhaust the bubbles, and if the interval is greater than 500 microns, chemical materials such as a cleaning solution and stripper may penetrate the uneven surface 54 because the passageway to exhaust the bubbles is too large. Also, it is preferable that the depth D of the depression portion 54c measured from the top of protrusion portion 54a or 54b is less than 10 microns to prevent chemical materials from penetrating the uneven surface 54.

The second adhesive layer 53 formed on the other surface of the supporting film 51 is in contact with a supporter (not shown), and does not have an uneven surface.

The first and second adhesive layers 52 and 53 may be made of a material such as a low temperature sensitive attachable additive, a high temperature sensitive attachable additive, a silicon additive, and/or an acrylic additive in one example.

FIG. 2 is a sectional view illustrating an adhesive tape for a flexible display device according to another embodiment of the present invention. An adhesion tape 55 according to this embodiment of the present invention includes a second adhesive layer 56 also having an uneven surface, which is different from the adhesion tape 50 shown in FIG. 1. Accordingly, the adhesion tape 55 may more completely exhaust the bubbles that are generated and formed between the adhesion tape 55 and the supporter (not shown).

Next, a method of manufacturing a flexible display device according to another embodiment of the present invention will be described in detail with reference to FIGS. 3 to 6.

FIGS. 3 to 6 are sectional views illustrating a manufacturing method of a flexible display device according to an embodiment of the present invention.

Referring to FIGS. 3 and 4, a flexible substrate 60 made of a plastic material, an adhesion tape 50, and a supporter 40 are provided and subsequently attached to the substrate 60. In other words, firstly a first adhesive layer 52 having an uneven surface 54 as one side of the adhesion tape 50 is attached to one surface of the flexible substrate 60, and the second adhesive layer 53 of the adhesion tape 50 is attached to the supporter 40. Because the adhesion tape 50 has the uneven surface 54, spaces are formed between the flexible substrate 60 and the first adhesive layer 52.

At this time, it is preferable that the attachment process between the first adhesive layer 52 and the flexible substrate 60 is executed in vacuum to minimize the inflow of bubbles. However, even if the bubbles are inflowed or generated from the additives, because the bubbles exhaust via the passageways between the flexible substrate 60 and the first adhesive layer 52, separation of the adhesion tape 50 and the flexible substrate 60 may be prevented during subsequent processes, even if the first and the second adhesive layers 52 and 53 do not have strong adhesive components.

The flexible substrate 60 includes an organic layer made of one material selected from polyacrylate, polyethylene-ether-phthalate, polyethylene-naphthalate, polycarbonate, polyarylate, polyether-imide, polyethersulfone, and polyimides. The flexible substrate 60 may further include an under-coating layer made of acrylic resin, a barrier layer of SiO2 or Al₂O₃, and a hard-coating layer made of acrylic resin, which are formed on both surfaces of the flexible substrate 60. These layers play a role in protecting the flexible substrate 60 from physical and chemical damage.

The adhesion tape 50 may be replaced with the adhesion tape 55 shown in FIG. 2.

The supporter 40 is used to prevent bending of the flexible substrate 60 in the manufacturing process of the flexible display device, and may be made of glass in one example.

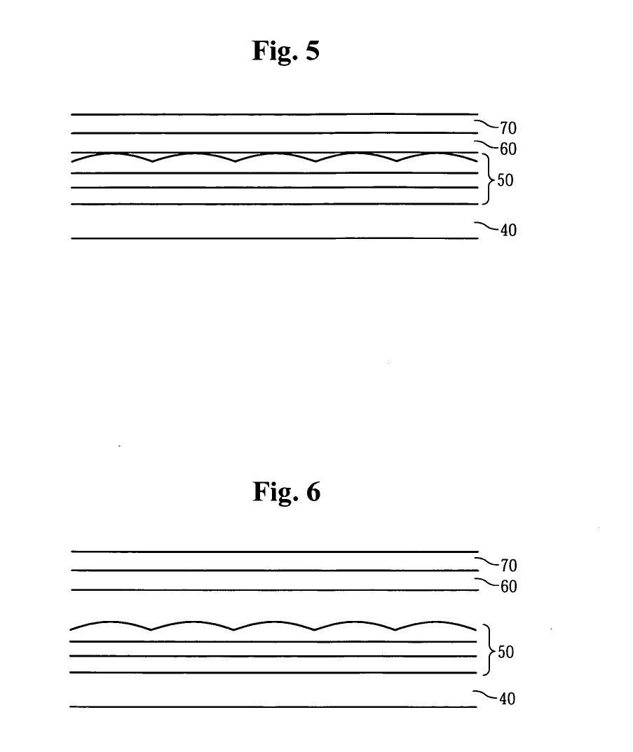

Next, as shown in FIG. 5, a thin film pattern 70 is formed on the flexible substrate 60 attached on the supporter 40 with the adhesion tape 50. At this time, because the flexible substrate 60 is combined with and supported by the supporter 40, the flexible substrate 60 does not bend and is extended.

Next, as shown in FIG. 6, the flexible substrate 60 on which the thin film pattern 70 is formed is divided from the supporter 40.

In one embodiment, the flexible substrate 60 may be used as a panel of a display device such as an LCD or an OLED, and this will be described in detail below with reference to the drawings.

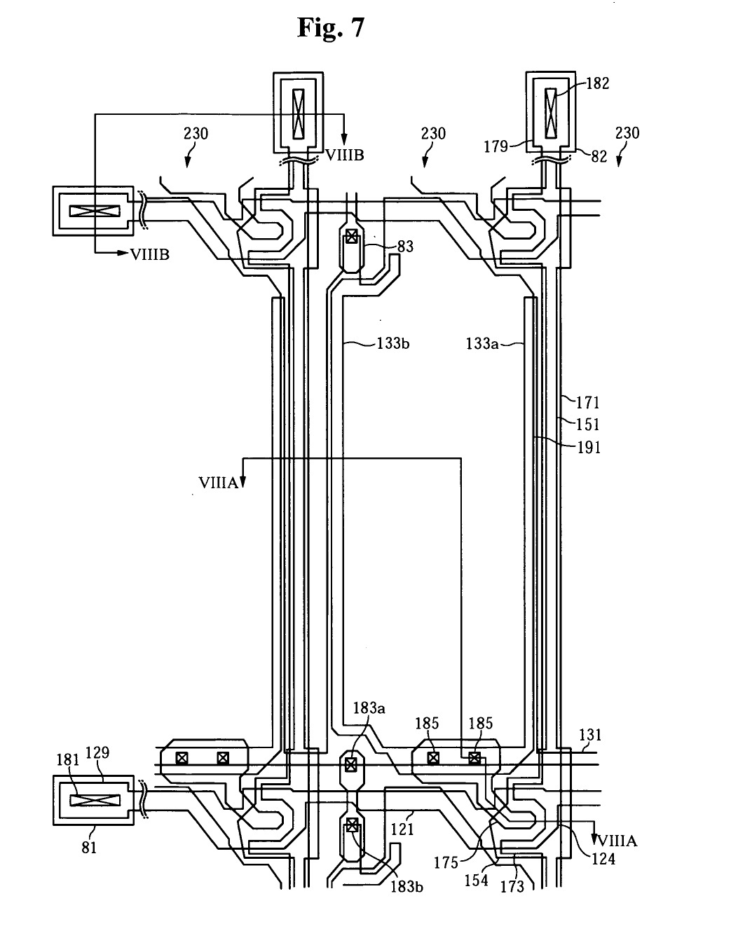

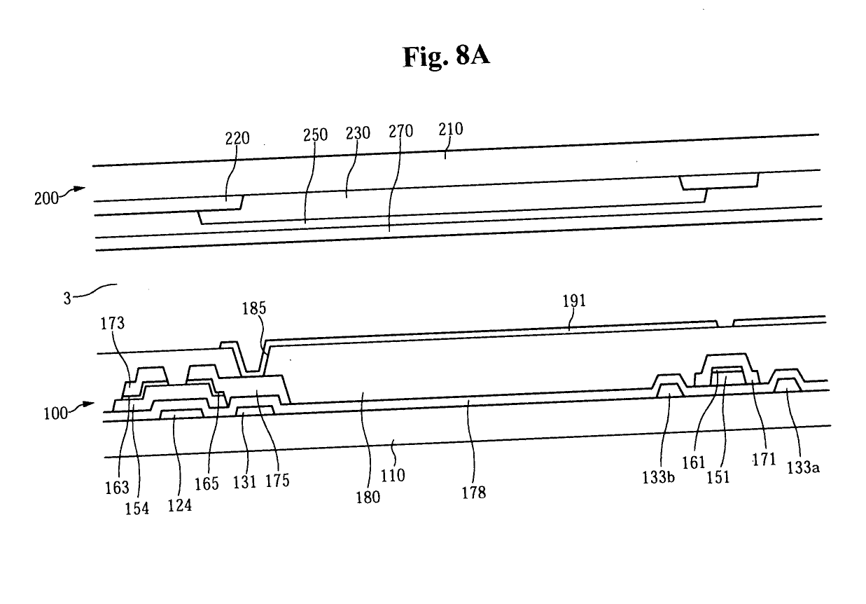

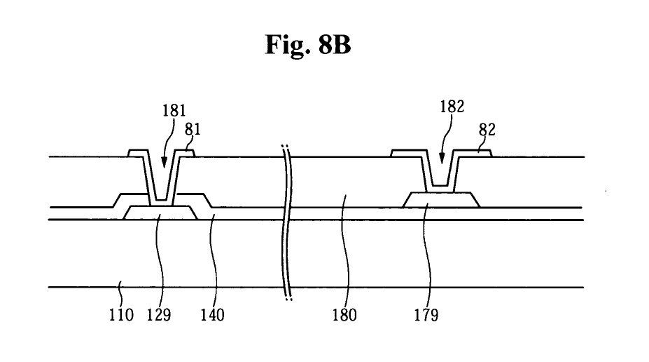

FIG. 7 is a layout view of an LCD according to an embodiment of the present invention, and FIGS. 8a and 8b are sectional views of the LCD shown in FIG. 7 taken along the lines VIIIA-VIIIA and VIIIB-VIIIB, respectively.

An LCD according to an embodiment of the present invention includes a TFT array panel 100, a common electrode panel 200, and an LC layer 3 interposed between the panels 100 and 200.

The TFT array panel 100 will be described in greater detail first.

A plurality of gate lines 121 and a plurality of storage electrode lines 131 are formed on a plastic substrate 110.

The gate lines 121 transmit gate signals and extend substantially in a transverse direction. Each of the gate lines 121 includes a plurality of gate electrodes 124 projecting upward and an end portion 129 having a large area for contact with another layer or an external driving circuit. A gate driving circuit (not shown) for generating the gate signals may be mounted on a flexible printed circuit (FPC) film (not shown), which may be attached to the substrate 110, directly mounted on the substrate 110, or integrated onto the substrate 110. The gate lines 121 may extend to be connected to a driving circuit that may be integrated on the substrate 110.

The storage electrode lines 131 are supplied with a predetermined voltage and each of the storage electrode lines 131 includes a stem extending substantially parallel to the gate lines 121 and a plurality of pairs of storage electrodes 133a and 133b branched from the stem. Each of the storage electrode lines 131 is disposed between two adjacent gate lines 121 and the stem is close to one of the two adjacent gate lines 121. Each of the storage electrodes 133a and 133b has a fixed end portion connected to the stem and a free end portion disposed opposite thereto. The fixed end portion of the storage electrode 133b has a large area, and the free end portion thereof is bifurcated into a linear branch and a curved branch. However, the storage electrode lines 131 may have various shapes and arrangements.

The gate lines 121 and the storage electrode lines 131 are preferably made of an Al-containing metal such as Al or an Al alloy, a Ag-containing metal such as Ag or an Ag alloy, a Cu-containing metal such as Cu or a Cu alloy, a Mo-containing metal such as Mo or a Mo alloy, Cr or a Cr alloy, Ta or a Ta alloy, or Ti or a Ti alloy. The lines may also have a multi-layered structure including two conductive films (not shown) having different physical characteristics. One of the two films is preferably made of a low resistivity metal including an Al-containing metal, a Ag-containing metal, and/or a Cu-containing metal for reducing signal delay or voltage drop. The other film is preferably made of a material such as a Mo-containing metal, a Cr-containing metal, a Ta-containing metal, or a Ti-containing metal, which has good physical, chemical, and electrical contact characteristics with other materials such as indium tin oxide (ITO) or indium zinc oxide (IZO). Examples of the combination of the two films are a lower Cr film and an upper Al (alloy) film and a lower Al (alloy) film and an upper Mo (alloy) film. However, the gate lines 121 and the storage electrode lines 131 may be made of various metals or conductors.

The lateral sides of the gate lines 121 and the storage electrode lines 131 are inclined relative to a surface of the substrate 110, and the inclination angle thereof ranges between about 30-80 degrees.

A gate insulating layer 140 preferably made of silicon nitride (SiNx) or silicon oxide (SiOx) is formed on the gate lines 121 and the storage electrode lines 131.

A plurality of semiconductor stripes 151 preferably made of hydrogenated amorphous silicon (abbreviated to “a—Si”), polysilicon, or an organic semiconductor are formed on the gate insulating layer 140. Each of the semiconductor stripes 151 extends substantially in the longitudinal direction and includes a plurality of projections 154 branched out toward the gate electrodes 124. The semiconductor stripes 151 extend substantially in the longitudinal direction and become wider near the gate lines 121 and the storage electrode lines 131 such that the semiconductor stripes 151 cover large areas of the gate lines 121 and the storage electrode lines 131.

A plurality of ohmic contact stripes and islands 161 and 165 are formed on the semiconductor stripes 151. The ohmic contact stripes and islands 161 and 165 are preferably made of n+hydrogenated a—Si heavily doped with an n-type impurity such as phosphorous, or they may be made of silicide in another example. Each ohmic contact stripe 161 includes a plurality of projections 163, and the projections 163 and the ohmic contact islands 165 are located in pairs on the projections 154 of the semiconductor stripes 151.

The lateral sides of the semiconductor stripes 151 and the ohmic contacts 161 and 165 are tapered, and the inclination angles thereof are preferably in a range between about 30-80 degrees.

A plurality of data lines 171 and a plurality of drain electrodes 175 are formed on the ohmic contacts 161 and 165 and the gate insulating layer 140.

The data lines 171 transmit data signals and extend substantially in the longitudinal direction to intersect the gate lines 121 and the storage electrode lines 131. Each data line 171 also intersects the storage electrode lines 131 and runs between adjacent pairs of storage electrodes 133a and 133b. Each data line 171 includes a plurality of source electrodes 173 projecting toward the gate electrodes 124 and an end portion 179 having a large area for contact with another layer or an external driving circuit. A data driving circuit (not shown) for generating the data signals may be mounted on a FPC film (not shown), which may be attached to the substrate 110, directly mounted on the substrate 110, or integrated with the substrate 110. The data lines 171 may extend to be connected to a driving circuit that may be integrated with the substrate 110.

The drain electrodes 175 are separated from the data lines 171 and disposed opposite the source electrodes 173 with respect to the gate electrodes 124. Each of the drain electrodes 175 includes a wide end portion and a narrow end portion. The wide end portion overlaps the storage electrode line 131 and the narrow end portion is partly enclosed by a source electrode 173.

A gate electrode 124, a source electrode 173, and a drain electrode 175 along with a projection 154 of a semiconductor stripe 151 forms a TFT having a channel formed in the projection 154 disposed between the source electrode 173 and the drain electrode 175. When the semiconductor stripe 151 is made of an organic material, the TFT is an organic TFT.

The data lines 171 and the drain electrodes 175 are preferably made of a refractory metal such as Cr, Mo, Ta, Ti, or alloys thereof. However, they may have a multilayered structure including a refractory metal film (not shown) and a low resistivity film (not shown). Examples of the multi-layered structure are a double-layered structure including a lower Cr/Mo (alloy) film and an upper Al (alloy) film and a triple-layered structure of a lower Mo (alloy) film, an intermediate Al (alloy) film, and an upper Mo (alloy) film. However, the data lines 171 and the drain electrodes 175 may be made of various metals or conductors.

The data lines 171 and the drain electrodes 175 have inclined edge profiles, and the inclination angles thereof range between about 30-80 degrees.

The ohmic contacts 161 and 165 are interposed only between the underlying semiconductor stripes 151 and the overlying conductors 171 and 175 thereon and reduce the contact resistance therebetween. Although the semiconductor stripes 151 are narrower than the data lines 171 at most places, the width of the semiconductor stripes 151 becomes larger near the gate lines 121 and the storage electrode lines 131 as described above, to smooth the profile of the surface, thereby substantially preventing disconnection of the data lines 171. However, the semiconductor stripes 151 include some exposed portions, which are not covered with the data lines 171 and the drain electrodes 175, such as portions located between the source electrodes 173 and the drain electrodes 175.

A passivation layer 180 is formed on the data lines 171, the drain electrodes 175, and the exposed portions of the semiconductor stripes 151. The passivation layer 180 is preferably made of an inorganic or organic insulator and it may have a flat top surface. Examples of the inorganic insulator include silicon nitride and silicon oxide. The organic insulator may have photosensitivity and a dielectric constant less than about 4.0. The passivation layer 180 may include a lower film of an inorganic insulator and an upper film of an organic insulator such that the layer includes the excellent insulating characteristics of the inorganic insulator while preventing the exposed portions of the semiconductor stripes 151 from being damaged by the organic insulator.

The passivation layer 180 has a plurality of contact holes 182 and 185 exposing the end portions 179 of the data lines 171 and the drain electrodes 175, respectively. The passivation layer 180 and the gate insulating layer 140 have a plurality of contact holes 181 exposing the end portions 129 of the gate lines 121, a plurality of contact holes 183a exposing portions of the storage electrode lines 131 near the fixed end portions of the storage electrodes 133b, and a plurality of contact holes 183b exposing the linear branches of the free end portions of the storage electrodes 133b.

A plurality of pixel electrodes 191, a plurality of overpasses 83, and a plurality of contact assistants 81 and 82 are formed on the passivation layer 180.

The pixel electrodes 191 are physically and electrically connected to the drain electrodes 175 through the contact holes 185 such that the pixel electrodes 191 receive data voltages from the drain electrodes 175. The pixel electrodes 191 supplied with the data voltages generate electric fields in cooperation with a common electrode 270 of a common electrode panel (200) supplied with a common voltage, which determine the orientations of liquid crystal molecules (not shown) of a liquid crystal layer 3 disposed between the two electrodes. A pixel electrode 191 and the common electrode form a capacitor referred to as a “liquid crystal capacitor,” which stores applied voltages after the TFT turns off.

A pixel electrode 191 overlaps a storage electrode line 131 including storage electrodes 133a and 133b. The pixel electrode 191 and a drain electrode 175 connected thereto and the storage electrode line 131 form an additional capacitor referred to as a “storage capacitor,” which enhances the voltage storing capacity of the liquid crystal capacitor.

The contact assistants 81 and 82 are connected to the end portions 129 of the gate lines 121 and the end portions 179 of the data lines 171 through the contact holes 181 and 182, respectively. The contact assistants 81 and 82 protect the end portions 129 and 179 and enhance the adhesion between the end portions 129 and 179 and external devices.

The overpasses 83 cross over the gate lines 121 and are connected to the exposed portions of the storage electrode lines 131 and the exposed linear branches of the free end portions of the storage electrodes 133b through the contact holes 183a and 183b, respectively, which are disposed opposite each other with respect to the gate lines 121. The storage electrode lines 131 including the storage electrodes 133a and 133b along with the overpasses 83 can be used for repairing defects in the gate lines 121, the data lines 171, or the TFTs.

The common electrode panel 200 will now be described in greater detail.

A light blocking member 220 called a black matrix for preventing light leakage between pluralities of pixels is formed on a flexible substrate 210 such as a plastic substrate. The light blocking member 220 may include a plurality of openings that face the pixels.

A plurality of color filters 230 are formed on the flexible substrate 210 and they are disposed substantially in the areas enclosed by the light blocking member 220. The color filters 230 may extend substantially along the longitudinal direction along the pixel column such that they may be stripe shaped. The color filters 230 may represent one of the primary colors such as red, green, and blue colors.

An overcoat 250 for preventing the color filters 230 from being exposed and for providing a flat surface is formed on the color filters 230 and the light blocking member 220.

A common electrode 270 preferably made of a transparent conductive material such as ITO and/or IZO is formed on the overcoat 250.

Alignment layers (not shown) are respectively formed on the inner surface of the two panels 100 and 200, and at least one polarizer is provided on the outer of two panels 100 and 200.

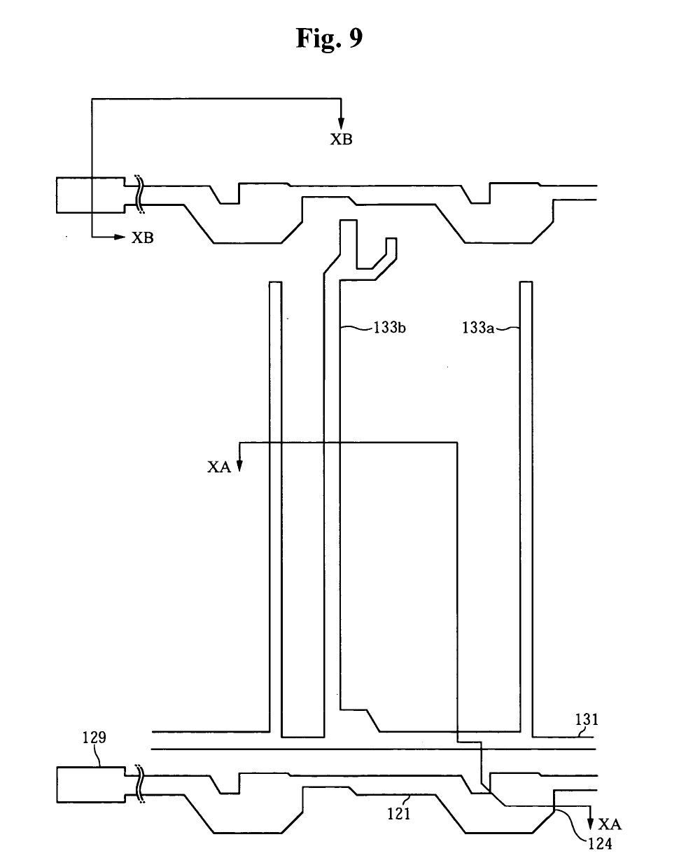

Now, a method of manufacturing the TFT array panel 100 shown in FIGS. 8A and 8B according to an embodiment of the present invention will be described in more detail with reference to FIGS. 9-16B as well as FIGS. 7-8B.

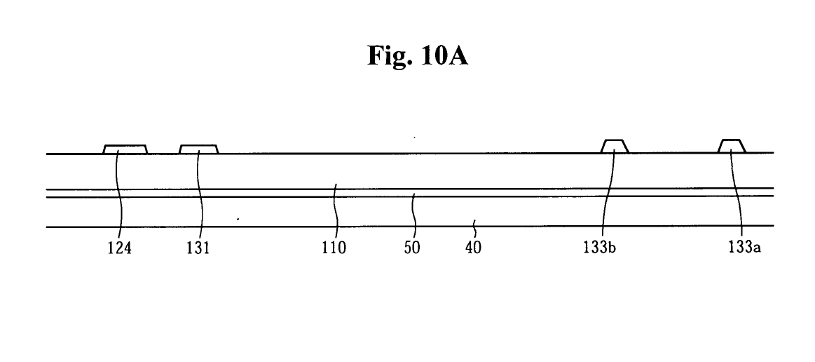

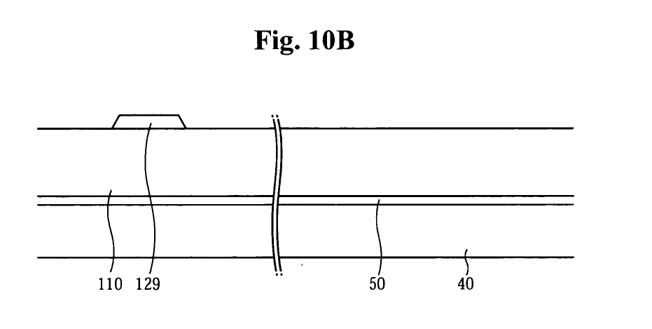

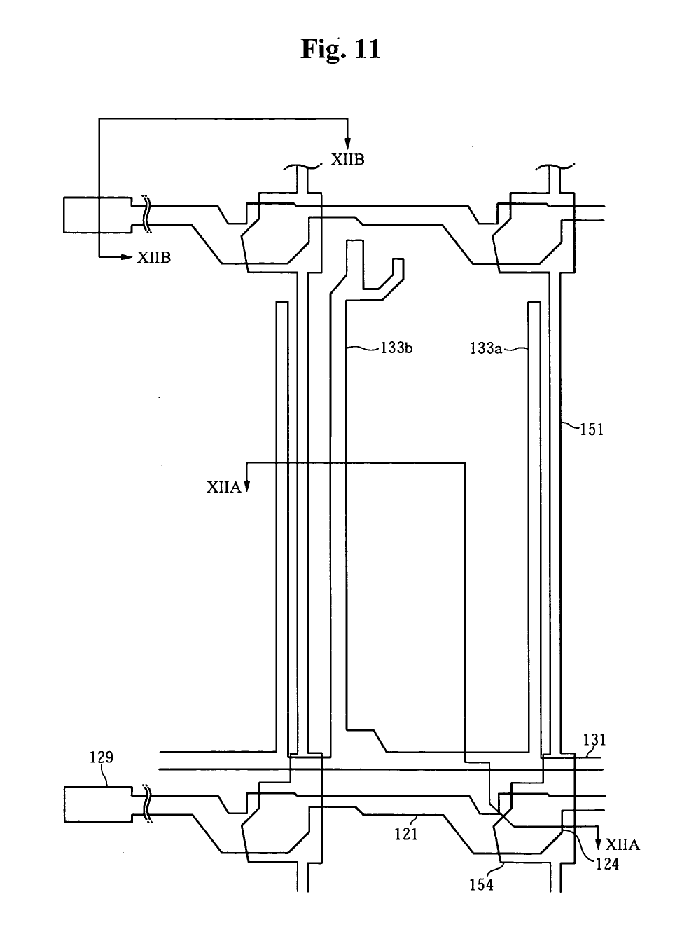

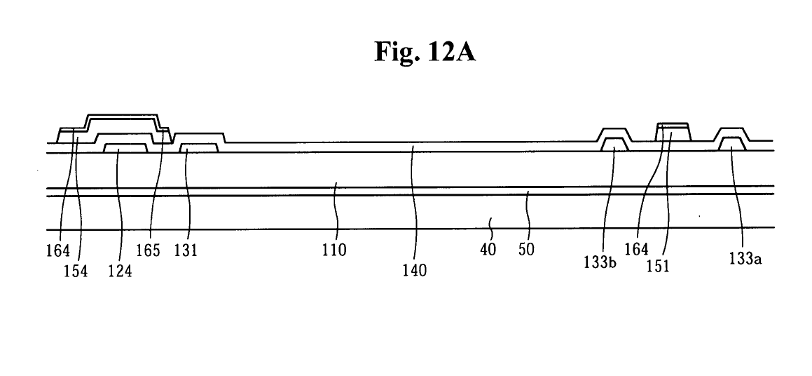

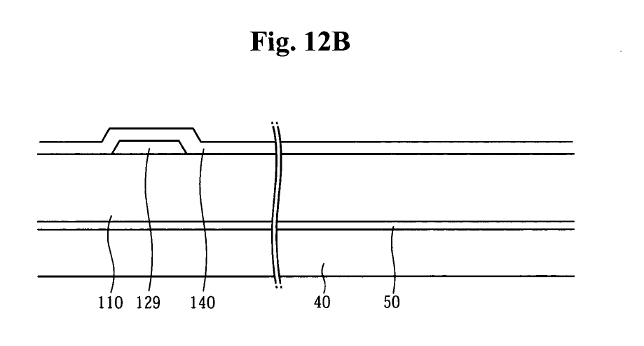

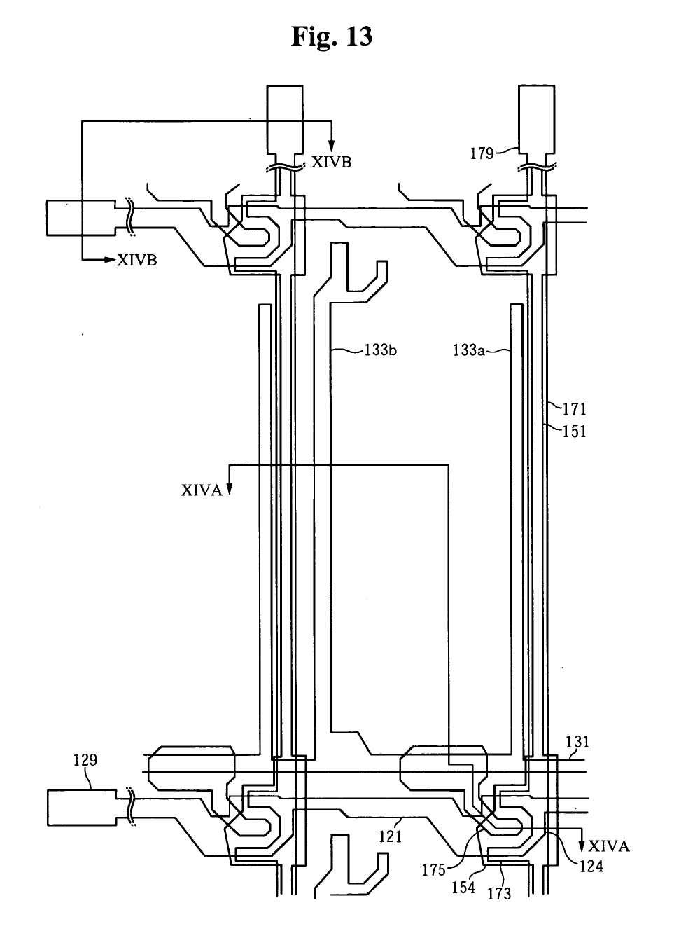

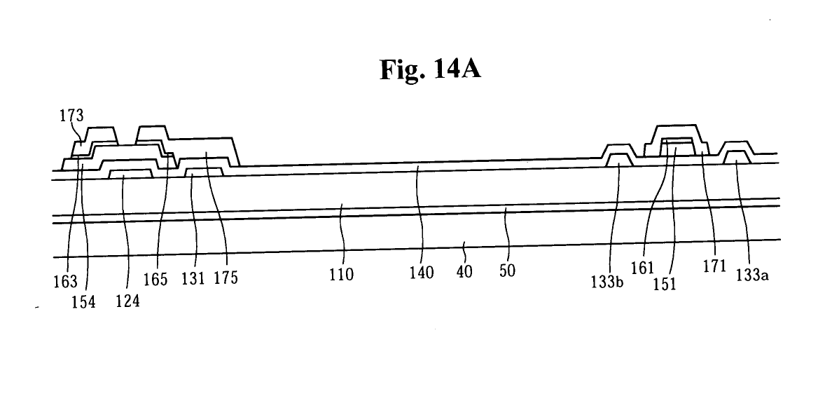

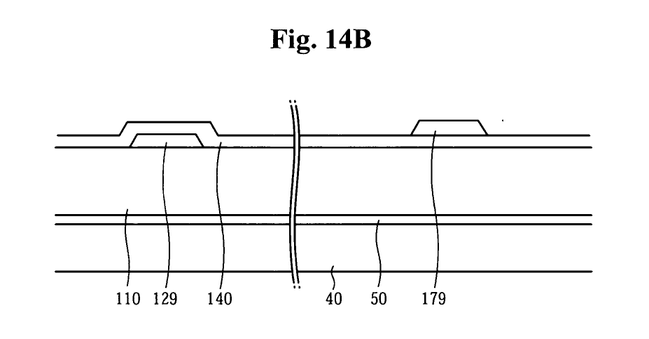

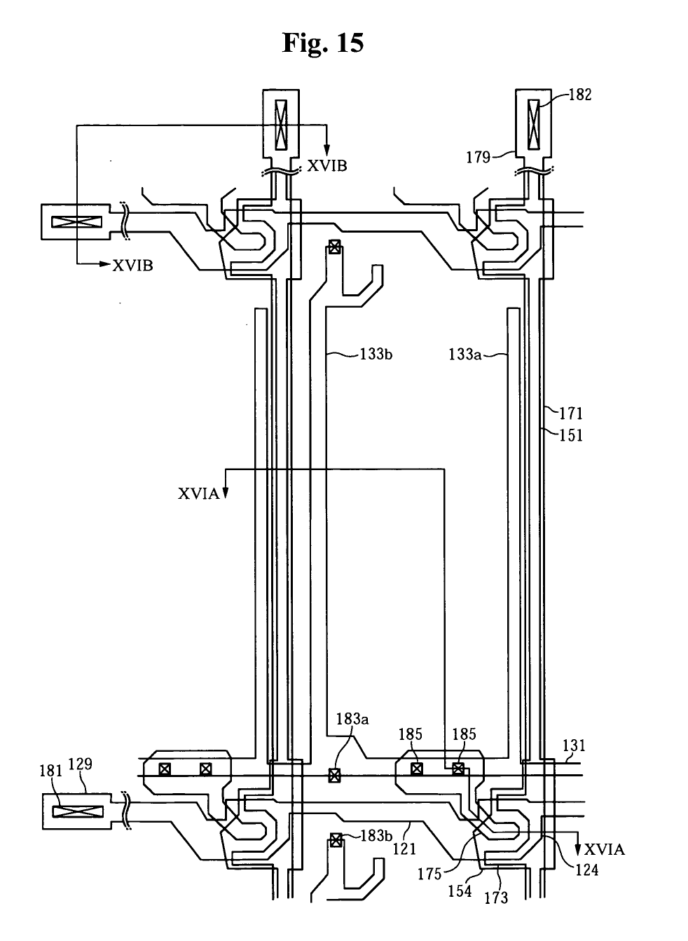

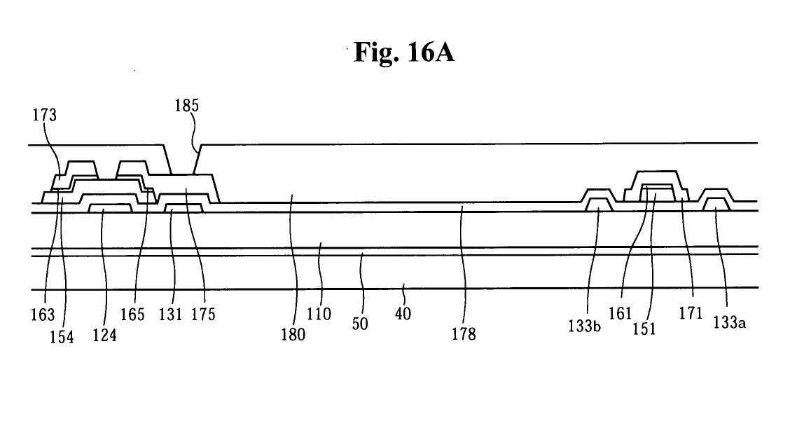

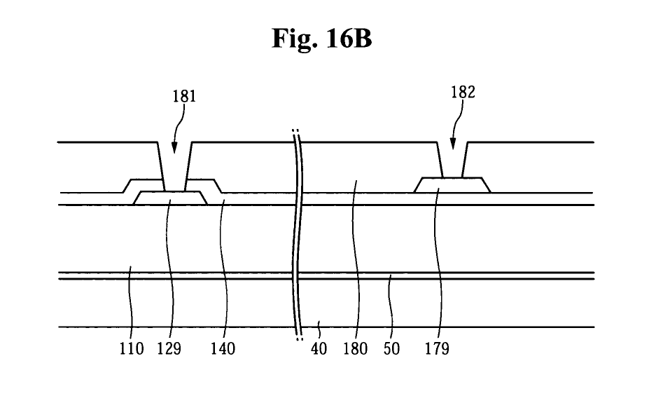

FIGS. 9, 11, 13, and 15 are layout views of a TFT array panel shown in FIGS. 7, 8A, and 8B in intermediate steps of a manufacturing method thereof according to an embodiment of the present invention. FIGS. 10A and 10B are sectional views of the TFT array panel shown in FIG. 9 taken along the lines XA-XA and XB-XB, respectively. FIGS. 12A and 12B are sectional views of the TFT array panel shown in FIG. 11 taken along the lines XIIA-XIIA and XIIB-XIIB, respectively. FIGS. 14A and 14B are sectional views of the TFT array panel shown in FIG. 13 taken along the lines XIVA-XIVA and XIVB-XIVB, respectively. FIGS. 16A and 16B are sectional views of the TFT array panel shown in FIG. 15 taken along the lines XVIA-XVIA and XVIB-XVIB, respectively.

As shown in FIGS. 9 to 10B a plastic substrate 110 is adhered on the supporter 40 using an adhesive member 50, and then a metal film is sputtered and patterned by photo-etching with a photoresist pattern on the flexible substrate 110 to form a plurality of gate lines 121 including a plurality of gate electrodes 124 and a plurality of end portions 129, and a plurality of storage electrode lines 131 including a plurality of storage electrodes 133a and 133b.

Referring to FIGS. 11 to 12B, after sequential deposition of a gate insulating layer 140, an intrinsic a—Si layer, and an extrinsic a—Si layer, the extrinsic a—Si layer and the intrinsic a—Si layer are photo-etched to form a plurality of extrinsic semiconductor stripes 164 and a plurality of intrinsic semiconductor stripes 151 including a plurality of projections 154 on the gate insulating layer 140.

Referring to FIGS. 13 to 14B, a metal film is sputtered and etched using a photoresist to form a plurality of data lines 171 including a plurality of source electrodes 173 and a plurality of end portions 179, and a plurality of drain electrodes 175.

Before or after removing the photoresist, portions of the extrinsic semiconductor stripes 164 that are not covered with the data lines 171 and the drain electrodes 175 are removed by etching to complete a plurality of ohmic contact stripes 161 including a plurality of projections 163 and a plurality of ohmic contact islands 165 and to expose portions of the intrinsic semiconductor stripes 151. Oxygen plasma treatment may follow thereafter in order to stabilize the exposed surfaces of the semiconductor stripes 151.

Referring to FIGS. 15 to 16B, an inorganic material is formed by plasma enhanced chemical vapor deposition (PECVD), or a photosensitive organic material is coated to form a passivation layer 180. Then, the passivation layer 180 is etched along with the gate insulating layer 140 to form a plurality of contact holes 181, 182, 183a, 183b, and 185.

Referring to FIGS. 7 to 8B, a conductive layer preferably made of a transparent material such as ITO, IZO, and a-ITO (amorphous indium tin oxide) is deposited by sputtering and is etched using the photoresist to form a plurality of pixel electrodes 190 and a plurality of contact assistants 81 and 82. The process of forming an alignment layer may be added.

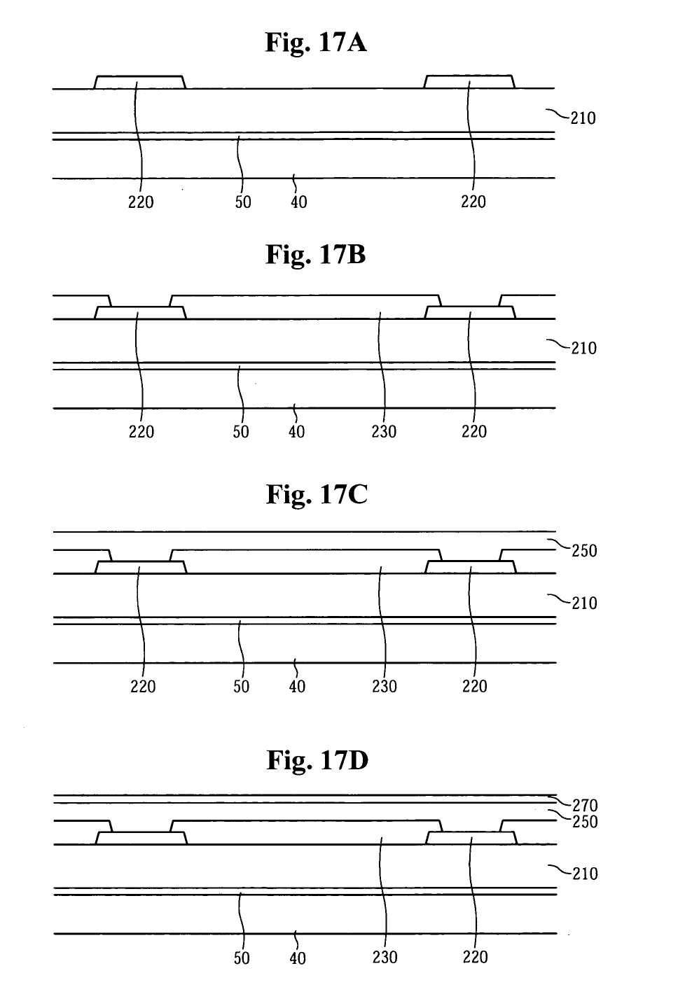

Now, a method of manufacturing the common electrode panel 200 shown in FIGS. 7-8B according to an embodiment of the present invention will be described in detail with reference to FIGS. 17A-17D.

As shown in FIG. 17A, a plastic substrate 210 is adhered on a supporter 40 using an adhesive member 50, then a thin film having good light blocking characteristics is deposited and patterned by photo-etching with a photoresist pattern on the plastic substrate 210 to form a light blocking member 220

As shown in FIG. 17B, photosensitive compositions are coated and patterned by photo-etching on the plastic substrate 210 to form a plurality of color filters 230 representing the other primary colors such as red, green, and blue colors.

Then, as shown in FIGS. 17C and 17D, an overcoat 250 is formed on the color filters 230 and the light blocking member 220, and a common electrode 270 preferably made of a transparent conductive material is formed on the overcoat 250.

Next, the thin film transistor array panel 100 and the common electrode panel 200 are combined with each other, and liquid crystal material is injected between the thin film transistor array panel 100 and the common electrode panel 200. At this time, the step forming a liquid crystal layer (not shown) by depositing liquid crystal material on one of the two panels 100 and 200 may be added before combining the two panels 100 and 200.

In the method of FIGS. 3 to 6, the thin film pattern 70 may include an organic thin film transistor including an organic semiconductor.

Furthermore, the method of FIGS. 3 to 6 as described above may be adapted to a panel for an OLED as well as the LCD.

As in the above descriptions, separation between the supporter and the flexible substrate may be prevented in the manufacturing processes without the bend phenomenon, even if the adhesive layers do not have strong adhesive ingredients. Accordingly, the production yield of a flexible display device may be improved and the manufacturing process is simplified.

While the present invention has been described in detail with reference to the preferred embodiments, those skilled in the art will appreciate that various modifications and substitutions can be made thereto without departing from the spirit and scope of the present invention as set forth in the appended claims.

What is claimed is:

1. An adhesion tape for a flexible display device, the adhesion tape comprising:
a supporting film;
a first adhesive layer formed on a first surface of the supporting film and having an uneven surface; and
a second adhesive layer formed on a second surface of the supporting film.

2. The adhesion tape of claim 1, wherein one surface of the second adhesive layer is uneven.

3. The adhesion tape of claim 1, wherein an interval between the heights of protrusion portions of the uneven surface is in a range between about 5 microns and about 500 microns.

4. The adhesion tape of claim 1, wherein the depth of the depression portion of the uneven surface is less than 10 microns.

5. The adhesion tape of claim 1, wherein the first and second adhesive layers include one of silicon additives and acrylic additives.

6. A method of manufacturing a flexible display device, the method comprising:
adhering an uneven surface of an adhesion tape to a first surface of a flexible substrate;
adhering a supporter to a second surface of the adhesion tape;
forming a thin film pattern on a second surface of the flexible substrate; and
separating the flexible substrate from the supporter.

7. The method of claim 6, wherein the second surface of the adhesion tape is uneven.

8. The method of claim 6, wherein an interval between the heights of the protrusion portions of the uneven surface is in a range between about 5 microns and about 500 microns.

9. The method of claim 6, wherein the depth of the depression portion of the uneven surface is less than 10 microns.

10. The method of claim 6, wherein the adhesion tape includes one of silicon additives and acrylic additives.

11. The method of claim 6, wherein the flexible substrate is coated with a hard-coating layer.

12. The method of claim 11, wherein the hard-coating layer includes acrylic resin.

13. The method of claim 12, wherein the flexible substrate includes:
an organic layer;
an under-coating layer formed on both surfaces of the organic layer;
a barrier layer formed on the under-coating layer; and
a hard-coating layer formed on the barrier layer.

14. The method of claim 13, wherein the organic layer is made of a material selected from the group consisting of polyacrylate, polyethylene-ether-phthalate, polyethylene-naphthalate, polycarbonate, polyarylate, polyether-imide, polyethersulfone, and polyimides.

15. The method of claim 13, wherein the under-coating layer and the hard-coating layer include acrylic resin.

16. The method of claim 13, wherein the barrier layer includes one of SiO₂ and Al₂O₃.

17. The method of claim 6, wherein the supporter includes glass.

18. The method of claim 6, wherein the thin film pattern includes an inorganic emitting layer.

19. The method of claim 6, wherein the thin film pattern includes an amorphous silicon thin film transistor.

20. The method of claim 6, wherein the thin film pattern includes an organic thin film transistor.
